(19) United States
(12) Patent Application Publication
(10) Pub. No.: US 2009/0092288 A1
(43) Pub. Date: Apr. 9, 2009

(54) IMAGE POSITION MEASURING APPARATUS AND EXPOSURE APPARATUS

(75) Inventors: Hiroshi Uemura, Kanagawa (JP); Takashi Fukui, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/993,901

(22) PCT Filed: Jun. 13, 2006
(86) PCT No.: PCT/JP2006/311880

§ 371 Date: Dec. 26, 2007

(30) Foreign Application Priority Data
Jun. 28, 2005 (JP) 2005-188044

(51) Int. Cl. G06K 9/00; G03B 27/68

(52) U.S. Cl. 382/106; 355/52

(57) ABSTRACT

An image position measuring apparatus is provided with a photographing unit including an image pickup device and/or a lens to measure a position of a reference mark formed on a work and a correcting unit for correcting distortion(s) of the image pickup device and/or the lens. An exposure apparatus is provided with an image position measuring apparatus and an exposure unit for exposing the work based on image data corrected based on positional information of the reference mark photographed by the image position measuring apparatus. Influences of the distortions of the image pickup device and the lens can be eliminated and accuracy of measurement of the position of the reference mark provided to the work can be improved.

### TECHNICAL FIELD

The present invention relates to an image position measuring apparatus including a photographing unit for measuring positions of reference marks formed on a work and an exposure apparatus including the image position measuring apparatus and for adjusting a position of an image to be formed on the work based on the positional information of the reference marks measured by the image position measuring apparatus.

### BACKGROUND TECHNIQUE

Conventionally, there is a known laser exposure apparatus for forming a wiring pattern on a printed wiring board (hereafter sometimes simply referred to as “board” or “photosensitive material”) as a work, for example. This laser exposure apparatus includes an exposure stage on which a printed wiring board that becomes a subject of image exposure is loaded and the exposure stage is moved along a predetermined transporting path.

To put it concretely, the exposure stage on which the printed wiring board is loaded moves at a predetermined speed in a sub-scanning direction and alignment holes (hereafter referred to as “alignment marks” or “reference marks”) formed at corner portions, for example, of the printed wiring board are photographed with a CCD camera in a predetermined reading position. Then, alignment of image data is carried out by performing coordinate transformation of a subject area of lithography in a lithography coordinate system in accordance with a position of the printed wiring board obtained by the photographing.

After carrying out the alignment, a photosensitive coating film formed on an upper face of the printed wiring board on the exposure stage is scanned and exposed in a predetermined exposure position with a laser beam modulated on the basis of the image data and deflected in a main scanning direction by a polygon mirror. Thus, an image (latent image) based on the image data (corresponding to the wiring pattern) is formed in a predetermined area (lithography area) on the printed wiring board.

The printed wiring board on which the image (latent image) is formed is unloaded from the exposure stage after the exposure stage returns to an initial position and the exposure stage from which the printed wiring board has been removed is transferred to the next process in which the next printed wiring board is exposed (see Patent Document 1, for example).

In the laser exposure apparatus for forming the image on the printed wiring board by modulating and applying the laser beam while transporting the board, the alignment marks which become reference of the exposure position are photographed and the exposure position is aligned with a proper position based on a result of measurement of the positions (reference position data) so as to accurately align the exposure position with the lithography area on the printed wiring board. In other words, the position of the board on the exposure stage and deformation of the board itself are measured and the position in which the image is exposed is corrected in accordance with the measured position and deformation.

Patent Document 1: Japanese Patent Application Laid-open No. 2000-338432

### DISCLOSURE OF THE INVENTION

### Problems to be Solved by the Invention

However, a lens used for photographing has distortions and an image pickup device such as a CCD camera also includes errors in a pitch of pixels and distortions of the device itself. Though the distortions are minute, they have nonnegligible influences on accuracy of photographing of the alignment marks when high accuracy of measurement of the positions of the alignment marks is required.

Therefore, with the above circumstances in view, it is an object of the invention to obtain an image position measuring apparatus with which influences of the distortions of an image pickup device and a lens can be eliminated and accuracy of measurement of positions of reference marks provided to a work can be improved and an exposure apparatus including the image position measuring apparatus.

### Approach for Solving the Problems

To achieve the above object, according to a first aspect of the invention, there is provided an image position measuring apparatus provided with a photographing unit including an image pickup device and/or a lens to measure a position of a reference mark formed on a work and a correcting unit for correcting distortion(s) of the image pickup device and/or the lens.

In the image position measuring apparatus according to the first aspect, the correcting unit may measure a distortion of a photographed image caused by the distortion(s) of the image pickup device and/or the lens in advance and may correct the photographed image data based on the measured distortion.

With the image position measuring apparatus having the above configuration, the photographed image data in which distortion(s) of the image pickup device and/or the lens is (are) corrected can be obtained and therefore it is possible to improve photographing accuracy (accuracy of measurement of the position) of the reference mark.

Moreover, in the image position measuring apparatus according to the first aspect, the photographing unit may include a mechanism for turning the lens about an optical axis and for fixing the lens.

With the image position measuring apparatus having the above configuration, it is possible to easily select and use an area of the lens where the distortion is the smallest. In general, the distortions increase when the magnification of the lens is increased. However, it is possible to select the area where the influence of the distortion is the smallest even if the magnification of the lens is increased and therefore it is possible to use a relatively inexpensive lens. Consequently, there is also a cost advantage.

Furthermore, in the image position measuring apparatus according to claim 1, a plurality of image pickup devices may be arranged one-dimensionally.

With the image position measuring apparatus having the above configuration, because the distortion correction data is only one-dimensional, it is possible to easily correct the photographed image data. Moreover, an area of the lens to be used is narrow and therefore it is easy to select the portion where the distortion of the lens is the smallest.

Furthermore, in the image position measuring apparatus according to the first aspect 1, a stage on which the work can be loaded and which is movable along a predetermined transporting path may be provided and the reference mark formed on the work may be photographed while moving the stage.

With the image position measuring apparatus having the above configuration, it is possible to increase processing efficiency of the work. Therefore, it is possible to increase productivity.

Moreover, according to a second aspect of the invention, there is provided an exposure apparatus provided with an image position measuring apparatus including a photographing unit having an image pickup device and/or a lens to measure a position of a reference mark formed on a work and a correcting unit for correcting distortion(s) of the image pickup device and/or the lens and an exposure unit for exposing the work based on image data corrected based on positional information of the reference mark photographed by the image position measuring apparatus.

With the exposure apparatus according to the second aspect, it is possible to accurately carry out the exposure treatment of the work.

### EFFECTS OF THE INVENTION

In any event, according to the invention, it is possible to provide the image position measuring apparatus with which the influence of the distortions of the image pickup device and the lens can be eliminated and accuracy of measurement of the position of the reference mark provided to the work can be improved and it is possible to provide the exposure apparatus including the image position measuring apparatus.

### BRIEF DESCRIPTION OF THE DRAWINGS

FIG. 1 A schematic perspective view of an exposure apparatus.

FIG. 2 A schematic side view of the exposure apparatus.

FIG. 3 A schematic plan view of the exposure apparatus.

FIG. 4 A schematic perspective view of an exposure stage.

FIG. 5 A schematic perspective view of an exposure head unit.

FIG. 6A A schematic plan view of an exposure area by the exposure head unit.

FIG. 6B A schematic plan view of an arrangement pattern of head assemblies.

FIG. 7 A schematic plan view of a state of arrangement of a dot pattern in a single head assembly.

FIG. 8 A schematic perspective view of an alignment unit.

FIG. 9 A schematic plan view of a photographed image and a reference chart.

FIG. 10A A schematic plan view of correction vectors.

FIG. 10B A drawing for explaining the correction vector.

FIG. 11 A schematic plan view showing a linear image sensor and a lens.

FIG. 12 A schematic plan view showing a photographed image and a reference chart by the linear image sensor.

FIG. 13 A graph showing an amount of correction derived from the photographed image and the reference chart.

FIG. 14 A schematic perspective view of a configuration of a camera portion.

FIG. 15 A graph showing the amount of correction derived from the photographed image and the reference chart.

FIG. 16 A control flow chart showing an exposure starting timing correcting routine.

### BEST MODE FOR CARRYING OUT THE INVENTION

The best mode for carrying out the present invention will be described below on the basis of an embodiment shown in the drawings.

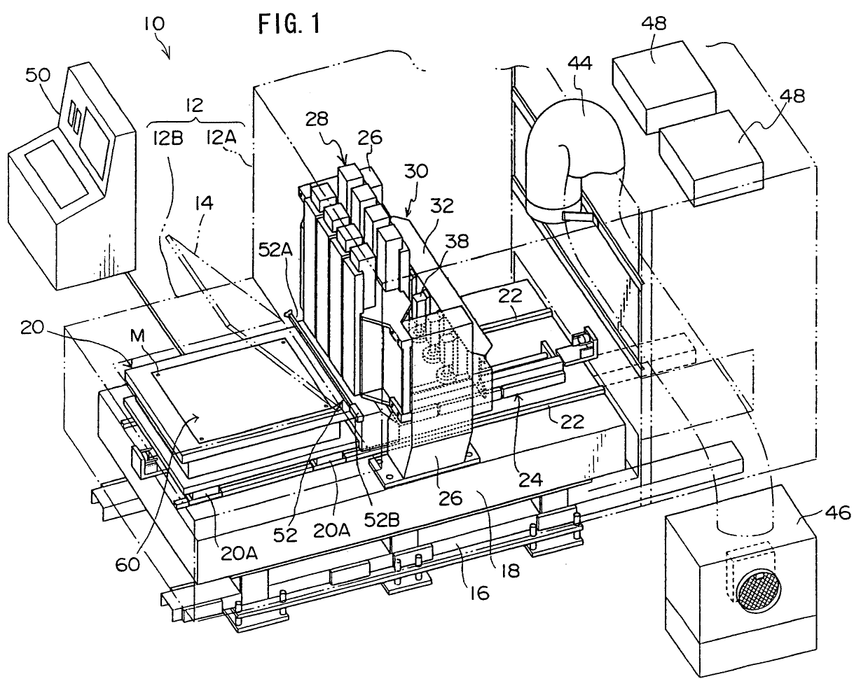

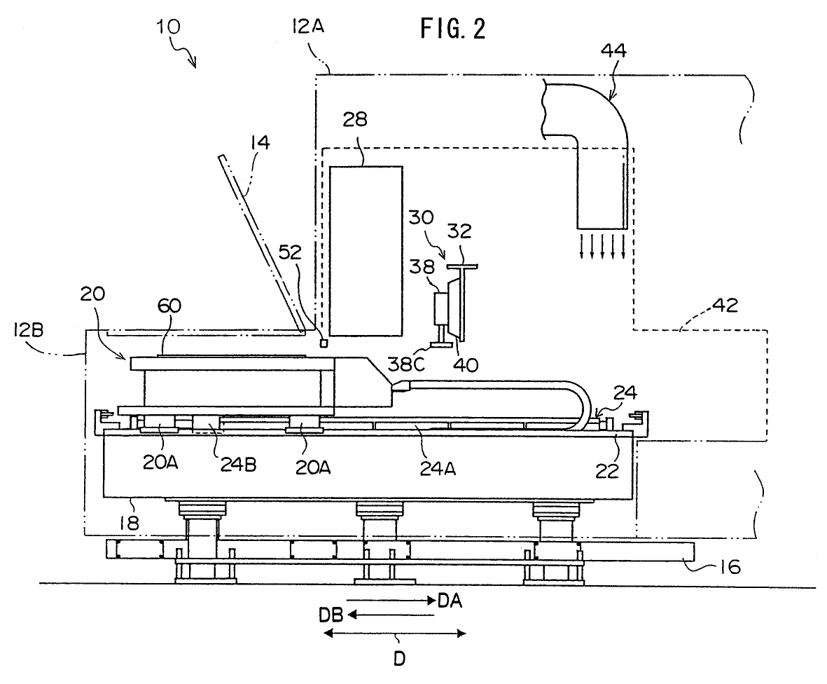

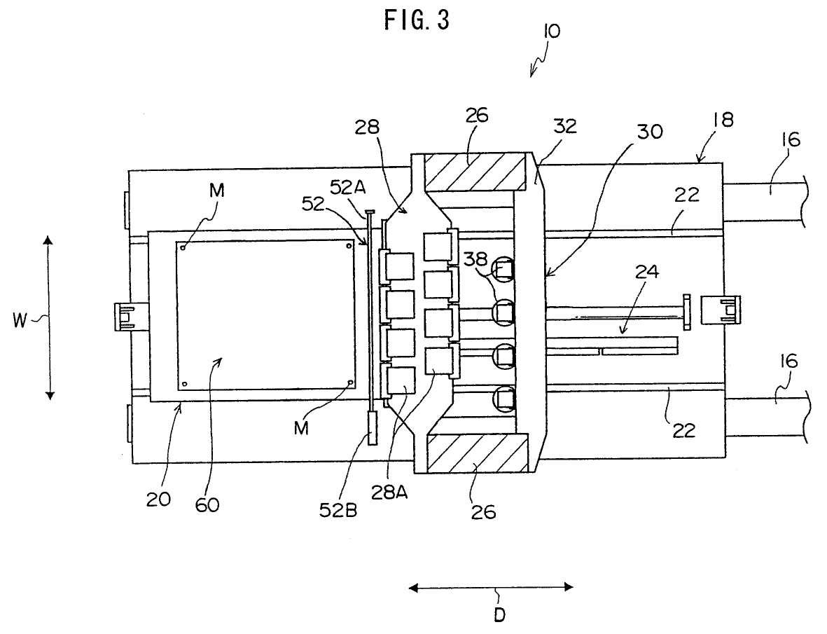

FIG. 1 is a schematic perspective view of an exposure apparatus according to the invention. FIG. 2 is a schematic side view of the exposure apparatus. FIG. 3 is a schematic plan view of the exposure apparatus. In FIG. 3, an arrow W indicates a width direction and an arrow D indicates a moving direction or a scanning direction. In FIG. 2, an arrow DA shows a going direction (outward direction) and an arrow DB shows a returning direction (homeward direction).

[Configuration of Exposure Apparatus]

As shown in FIGS. 1 to 3, the exposure apparatus 10 is formed by housing respective portions in a rectangular frame body 12 formed by assembling rod-shaped square pipes into a frame shape. Panels (not shown) are stuck on the frame body 12. Thus, the exposure apparatus 10 is isolated from the outside.

The frame body 12 is formed of a tall case portion 12A and a stage portion 12B provided to protrude from one side face of the case portion 12A. An upper face of the stage portion 12B is positioned lower than the case portion 12A and substantially at a height of a waist of an operator standing in front of the stage portion 12B.

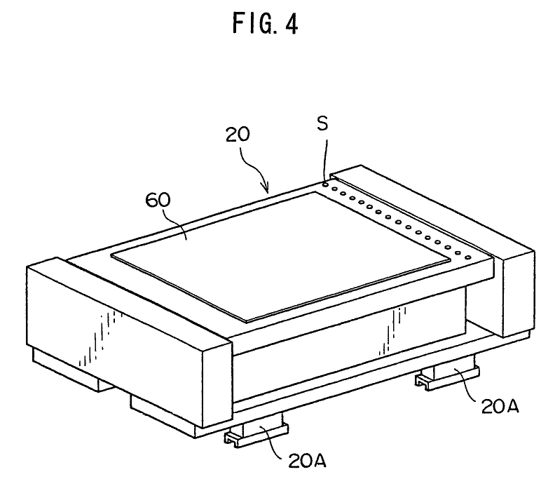

The upper face of the stage portion 12B is provided with an opening/closing lid 14. One side of the opening/closing lid 14 on a side of the case portion 12A is hinged (not shown) and the opening/closing lid 14 can be opened and closed about the one side. On the upper face of the stage portion 12B, an exposure stage 20 (see FIG. 4) can be exposed when the opening/closing lid 14 is opened.

Moreover, a surface plate 18 which becomes reference of a movement locus of the exposure stage 20 extends from the stage portion 12B to the case portion 12A. The surface plate 18 is supported on a mount 16 firmly fixed to the square pipes forming the case portion 12A. One end portion in a longitudinal direction (moving direction) of the surface plate 18 reaches the stage portion 12B and the operator can load or unload a photosensitive material 60 on or from the exposure stage 20 when the exposure stage 20 is in this position.

A pair of parallel sliding rails 22 is provided on an upper face of the surface plate 18 along its longitudinal direction. Leg portions 20A (see FIG. 4) mounted to a lower face of the exposure stage 20 and having substantially angular U sectional shapes are supported to be able to slide on the sliding rails 22. As a result, the exposure stage 20 is supported on the sliding rails 22 and therefore can slide in a scanning direction almost without frictional resistance (or only with rolling resistance when bearings or the like are interposed).

Furthermore, a linear motor portion 24 is provided on the upper face of the surface plate 18 and between the pair of sliding rails 22. The linear motor portion 24 is a linear driving source to which a driving force of a stepping motor is applied and is formed of a rod-shaped stator portion (magnet portion) 24A (see FIG. 2) provided along the longitudinal direction of the surface plate 18 and a coil portion 24B provided on a lower face side of the exposure stage 20 while leaving certain space to the stator portion 24A.

Therefore, the exposure stage 20 is structured so that a driving force is obtained by the action of magnetic force between a magnetic field produced by energization of the coil portion 24B and a magnetic field of the stator portion 24A to thereby move the surface plate 18 in its longitudinal direction (scanning direction) along the sliding rails 22. Because the principle is the same as that of the stepping motor, the exposure stage 20 has a constant speed property and positioning accuracy and driving of the exposure stage 20 can be controlled with high accuracy by electrical control with respect to torque variation at the times of start and stop and the like.

A linear encoder (not shown) is attached to the linear motor portion 24. The linear encoder outputs pulse signals to a pulse counter when the coil portion 24B moves in the scanning direction together with the exposure stage 20 with respect to the stator portion 24A, the polarity of the pulse signals corresponding to a going or returning moving direction of the exposure stage 20 and the number of pulses being proportional to an amount of the movement.

The rectangular flat photosensitive material 60 which is a subject of exposure is loaded on the upper face of the exposure stage 20 while positioned in a predetermined position by a positioning means (not shown). The exposure stage 20 is formed in its load surface with a plurality of grooves (not shown). After the photosensitive material 60 is loaded thereon and positioned in a predetermined position, negative pressure is caused in the grooves by a vacuum pump or the like to thereby suck and retain the photosensitive material 60 to the exposure stage 20.

The photosensitive material 60 is provided with a plurality of alignment marks (reference marks) M indicating reference of an exposure position in a lithography area on a surface of the material 60 to be exposed. The alignment marks M are formed of circular through holes and one mark M (and four in total) is formed in a vicinity of each corner portion of the photosensitive material 60 as shown in FIG. 3, for example.

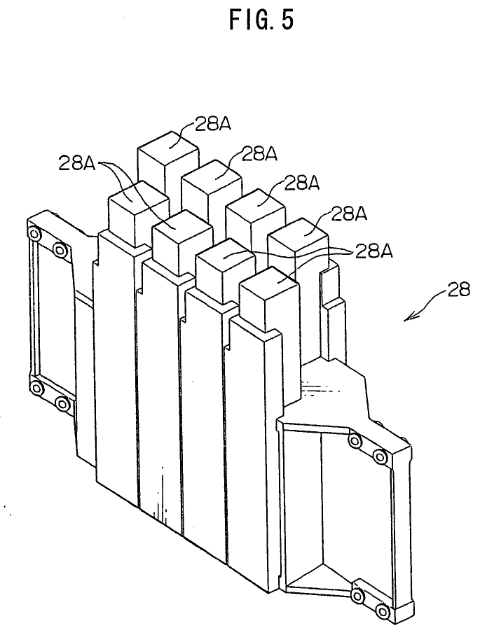

In a substantially middle position of a movement locus of the exposure stage 20 on the surface plate 18, an exposure head unit 28 (see FIG. 5) is disposed. The exposure head unit 28 is supported so as to bridge between a pair of support columns 26, the support columns 26 respectively provided to stand on outer sides of opposite end portions in a width direction of surface plate 18, so that the exposure stage 20 can pass through between the exposure head unit 28 and the surface plate 18.

The exposure head unit 28 is formed by arranging a plurality of head assemblies 28A along the width direction of the surface plate 18. By applying a plurality of light beams from the respective head assemblies 28A to the photosensitive material 60 on the exposure stage 20 at predetermined times while moving the exposure stage 20 at a constant speed, the surface of the photosensitive material 60 to be exposed (lithography area) can be exposed.

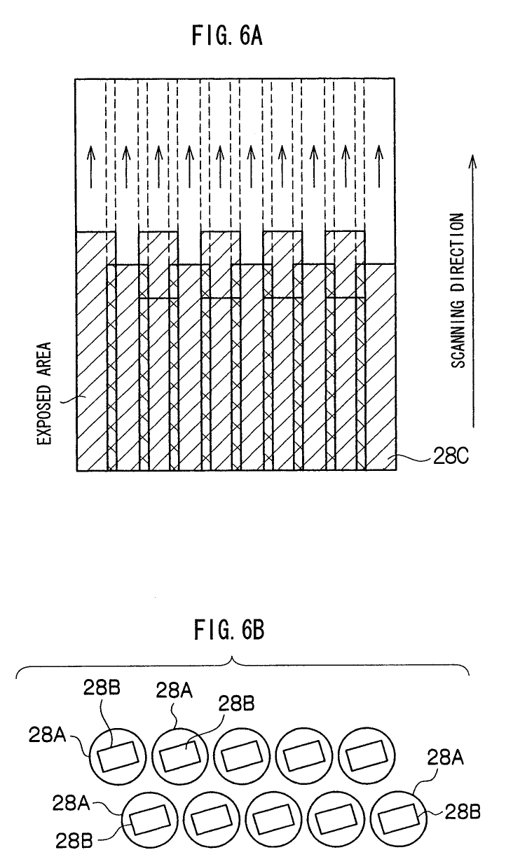

The head assemblies 28A forming the exposure head unit 28 are arranged substantially in a form of a matrix with m rows and n columns (two rows by five columns, for example) as shown in FIG. 6B and the plurality of head assemblies 28A are arranged in a direction (width direction) orthogonal to the moving direction (scanning direction) of the exposure stage 20. Here, in relation to the width of the photosensitive material 60, ten head assemblies 28A in total in two rows and five columns are employed.

Moreover, an exposure area 28B by one head assembly 28A is in a rectangular shape having short sides in the scanning direction and inclined at a predetermined inclination with respect to the scanning direction. As the exposure stage 20 moves, a belt-shaped exposed area 28C is formed by each head assembly 28A on the photosensitive material 60 (see FIG. 6A).

On the other hand, as shown in FIG. 1, light source units 48 are disposed in another place in the case portion 12A where the units 48 do not obstruct movement of the exposure stage 20 on the surface plate 18. The light source units 48 include a plurality of lasers (semiconductor lasers) and lights radiated from the lasers are guided to the respective head assemblies 28A through optical fibers (not shown).

Each of the head assemblies 28A controls the light beam guided and radiated by the optical fiber dot by dot by using digital micromirror devices (DMDs) (not shown) which are spatial light modulators and dot patterns are formed on the photosensitive material 60 by exposure. Here, density of one pixel is expressed by using a plurality of dot patterns.

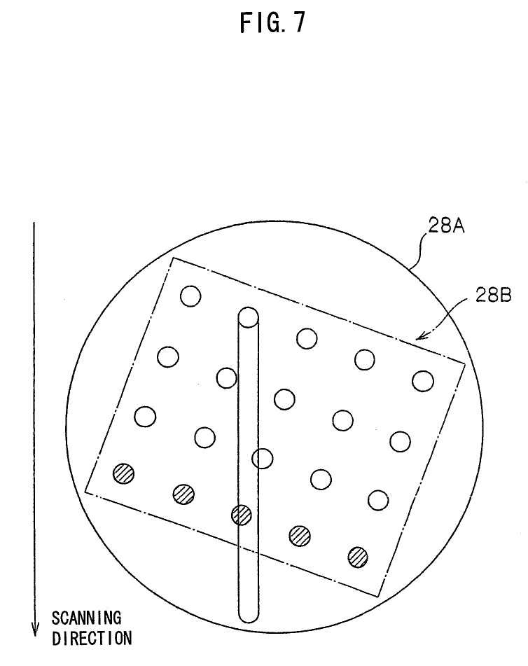

Furthermore, as shown in FIG. 7, the exposure area 28B (one head assembly 28A) is formed of twenty dots arranged in a two-dimensional arrangement (4×5, for example). Because the dot pattern of the two-dimensional arrangement is inclined with respect to the scanning direction, the respective dots arranged in the scanning direction pass through between dots arranged in a direction intersecting with the scanning direction to thereby narrow a substantial pitch of dots. As a result, it is possible to obtain high resolution.

Because the head assemblies 28A are inclined as described above, a plurality of dot patterns may overlap each other on the same scanning line depending on setting of standard resolution of the exposure apparatus 10 in some cases. In such cases, DMDs corresponding to either one of the dot patterns (the hatched dot pattern in FIG. 7, for example) are maintained in an OFF state to provide unused dot pattern.

Here, the photosensitive material 60 positioned and loaded on the exposure stage 20 is exposed not when the photosensitive material 60 is loaded on the exposure stage 20 and the exposure stage 20 moves to a farther side (going route) along the sliding rails 22 on the surface plate 18 but when the exposure stage 20 returns (returning route) to the stage portion 12B after it reaches a farther end portion (on the case portion 12A side) of the surface plate 18.

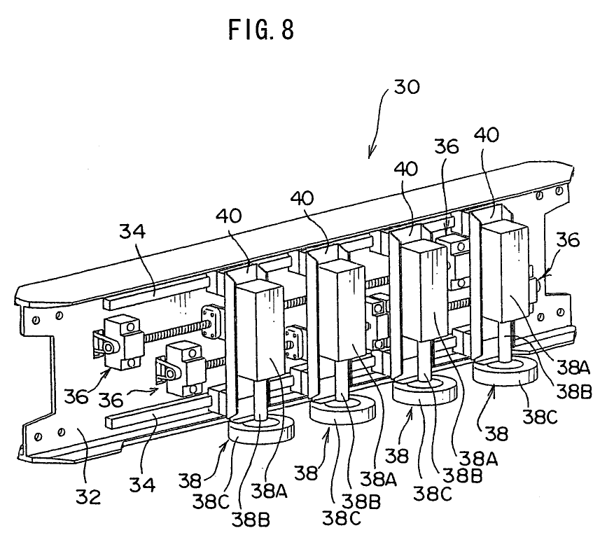

In other words, the going traveling of the exposure stage 20 is movement for obtaining positional information of the photosensitive material 60 on the exposure stage 20 and an alignment unit 30 (image position measuring apparatus) shown in FIG. 8 is disposed on the surface plate 18 as a unit for obtaining the positional information. The alignment unit 30 is disposed on a farther side of the exposure head unit 28 in the going direction and supported to bridge between the pair of support columns 26, the support columns 26 respectively provided to stand on the outer sides of the opposite end portions in the width direction of the surface plate 18.

The alignment unit 30 is formed of a base portion 32 fixed at its opposite ends to the pair of support columns 26 and a plurality of (four, for example) camera portions 38 provided to one face (the face facing the exposure head unit 28) in the scanning direction of the base portion 32 to be movable in the width direction of the surface plate 18. The camera portions 38 are slidably mounted through camera bases 40 to a pair of parallel rail portions 34 disposed along the base portion 32 and can move independently of each other.

Moreover, in each of the camera portions 38, a lens portion 38B is provided to a lower face of a camera main body 38A (image pickup device) and a ring-shaped stroboscopic light source (LED stroboscopic light source) 38C is mounted to a protruding tip end portion of the lens portion 38B. The lens portion 38B is disposed face-down so that a lens optical axis is substantially vertical. Light from the stroboscopic light source 38C is applied to the photosensitive material 60 on the exposure stage 20 and the reflected light is input to the camera main bodies 3 8A through the lens portions 3 8B to thereby photograph the alignment marks M on the photosensitive material 60.

The camera bases 40 can be moved in the width direction of the surface plate 18 by driving of ball screw mechanism portions 36, respectively. By the movement of the exposure stage 20 and the movement in the width direction of the surface plate 18 by the driving force of the ball screw mechanism portions 36, it is possible to dispose the optical axes of the lens portions 38B in desired positions of the photosensitive material 60.

Here, the camera main body 38A (image pickup device) includes errors in a pitch of pixels and distortions of the device itself and the lens portion 38B also includes distortions. Though these distortions are minute, they have nonnegligible influences on accuracy of photographing of the alignment marks M when high accuracy of measurement of the positions of the alignment marks M is required. Therefore, the camera main bodies 38A and the lens portions 38B are provided with distortion correcting units 70.

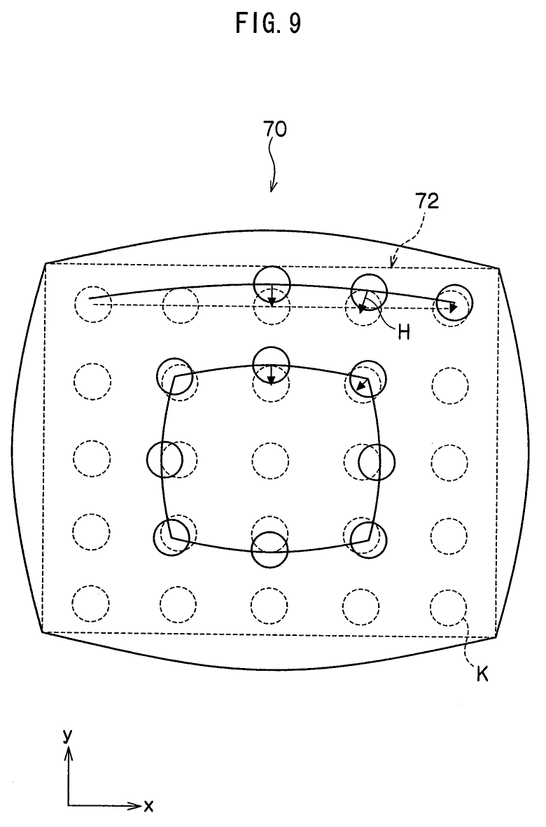

As the distortion correcting unit 70, it is conceivable that a reference chart 72 (shown in dotted lines) for correcting distortions is photographed and that distortions (correction vectors H) of the image in a field of view are measured and corrected as shown in FIG. 9, for example. In other words, the reference chart 72 is made of material such as glass having accuracy that is not impaired (dimensionally unchanging over time). A plurality of chrome plating patterns K are formed on the reference chart 72 so that relative positions of pixels (dots) to those of the actual photographed image (shown in solid liens) can be seen.

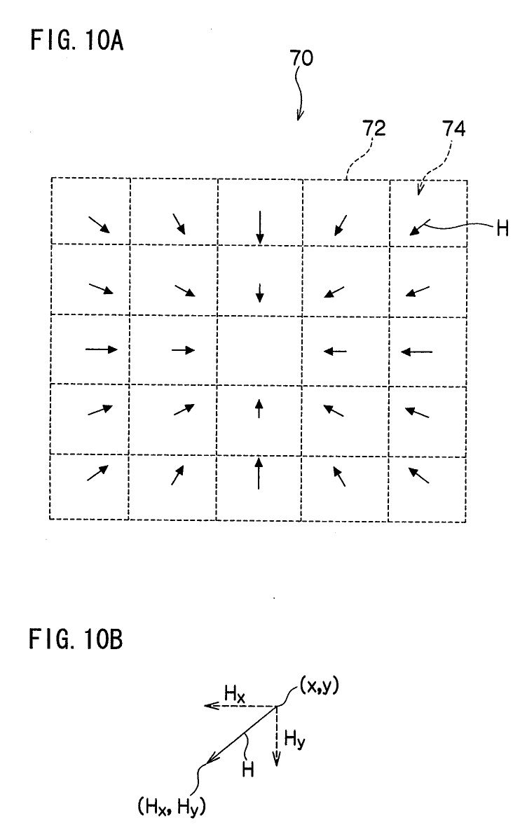

For example, in a case of a two-dimensional area CCD, the chrome plating pattern K is formed in a grid shape to measure the correction vector H (a direction and an amount of correction) in each area 74 shown in FIG. 10A. Therefore, based on the measurement result, if the correction vector H is calculated for each area 74 and the distortion correction data derived from the correction vector H is retained as a fixed value for each area 74, it is possible to automatically carry out correction of the photographed data pixel by pixel (for each area 74) when the alignment marks M are photographed.

Alternatively, it is also possible that the correction vector H is retained as a function f of x and y coordinates in the field of view as shown in FIG. 10B. In other words, the amount of correction (Hx, Hy) in directions x and y of the correction vector H is expressed as a function of (Hx, Hy)=(f1(x, y)), f2(x, y)), (f1, f2: functions of (x, y)) to automatically carry out the correction by using the functions f1, f2 when the alignment marks M are photographed.

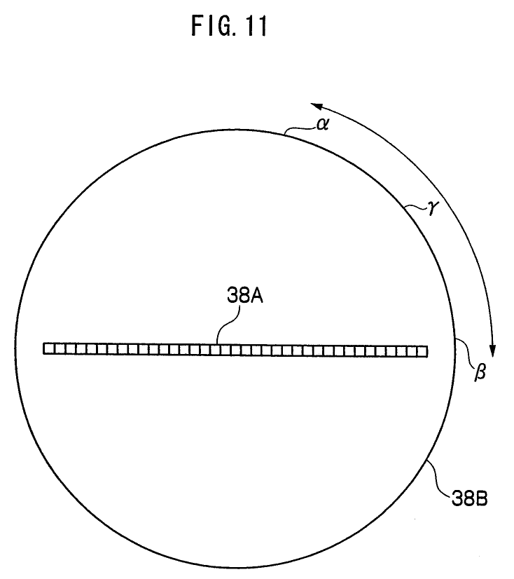

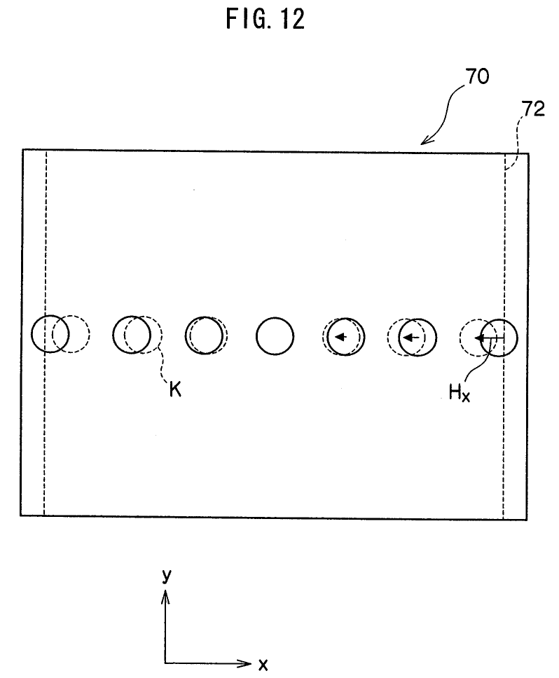

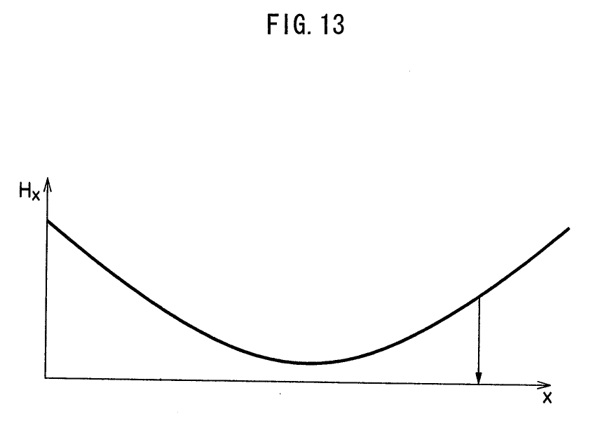

It is preferable that the camera main body 38A (image pickup device) is a linear image sensor (line CCD) arranged one-dimensionally as shown in FIG. 11. In this case, the alignment marks M are photographed while divided in a plurality of rows in the scanning direction (direction of the arrow D). With this configuration, influences (correction vectors H) of the distortions of the camera main body 38A and the lens portion 38B are in only one direction (x direction) (linear) as shown in FIG. 12 and therefore it is possible to easily correct the photographed image data. FIG. 13 is a graph showing the amount of distortion (amount of correction) Hx on the chrome plating patterns K (in the direction x) shown in FIG. 12.

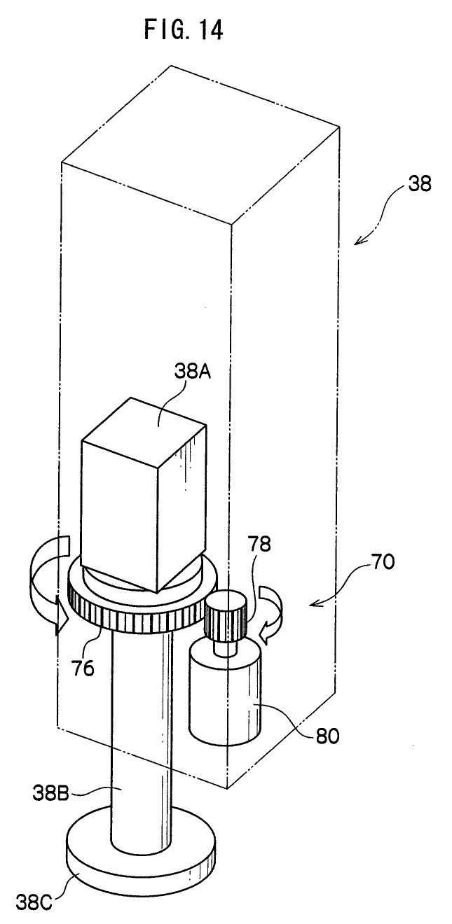

Furthermore, it is preferable that each of the lens portions 38B can be turned (rotated in normal and reverse directions) about the optical axis and fixed in any position. In other words, a driven gear 76 pivoted to be coaxial with the optical axis is secured to an upper portion of the lens portion 38B and a stepping motor 80 having a driving gear 78 engaged with the driven gear 76 is provided as shown in FIG. 14, for example. With this configuration, the driven gear 76 can be rotated in the normal and reverse directions through the driving gear 78 by rotation of the stepping motor 80 in the normal and reverse directions and therefore it is possible to rotate the lens portion 38B in the normal and reverse directions.

Therefore, it is possible to easily select and use a portion of the lens portion 38B where the distortion is the smallest to thereby improve the accuracy of photographing (accuracy of measurement of the positions) of the alignment marks M. Especially, if the camera main body 3 8A is the linear image sensor (line CCD) as shown in FIG. 11, a lens area of the lens portion 38B is narrowed (into a line) and therefore it is possible to easily select the portion there the distortion is the smallest by turning (rotation in the normal and reverse directions) of the lens portion 38B.

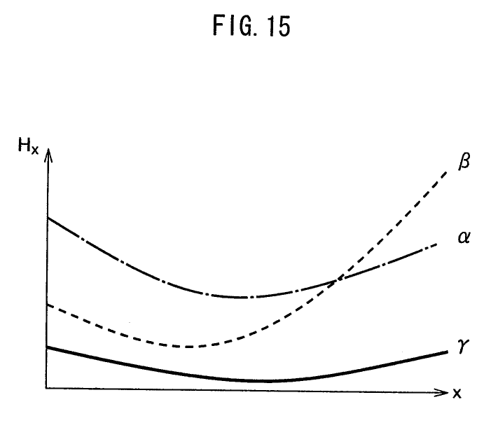

For example, as shown in FIG. 15, if curves α, β, and γ representing amounts of distortions (amounts of correction) Hx in the direction x respectively correspond to portions α, β, and γ shown in FIG. 11, it is possible to select the portion γ where a value of the amount of distortion (amount of correction) Hx is the smallest to photograph the alignment marks M. In this way, it is possible to easily select an area having the smallest influence of distortion even when magnification of the lens is increased and therefore there is an advantage that a relatively inexpensive lens can be used.

In any event, the relative positional relationship between the exposure stage 20 and the photosensitive material 60 is determined when the operator loads the photosensitive material 60 on the exposure stage 20 and therefore a slight displacement may be caused in some cases. Therefore, it is necessary to photograph the alignment marks M with the camera portions 38.

As a result, the positional displacement of the photosensitive material 60 loaded on the exposure stage 20 is recognized and it is possible to optimize the relative positions of the photosensitive material 60 and the image data to each other (exposure starting position) by correcting the exposure timing of the exposure head unit 28 to which the relative position to the exposure stage 20 is known.

As shown in FIG. 4, at an end portion of the upper face of the exposure stage 20 on the side in the going direction, a reference scale S for camera correction, which is related to detecting positions of the camera portions 38 to carry out alignment based on the positions, is provided. The reference scale S is made of material such as glass having accuracy that is not impaired (dimensionally unchanging over time) and a plurality of marks are provided at regular intervals on an upper face of the scale S. By photographing the marks with the camera portions 38, the positions of the camera portions 38 with respect to the upper face of the exposure stage 20 are accurately known and it is possible to photograph (measure) the alignment marks M with the camera portions 38 even when the photosensitive material 60 is loaded on the exposure stage 20 while displaced.

Moreover, the linear motor portion 24 for moving the exposure stage 20, the head assemblies 28A, the camera portions 38, and the like are connected to a controller portion 50 for controlling them. With this controller portion 50, the exposure stage 20 is controlled to move at a predetermined speed, the camera portions 38 are controlled to photograph the alignment marks M on the photosensitive material 60 at the predetermined timing, and the head assemblies 28A are controlled to expose the photosensitive material 60 at the predetermined timing.

With the controller portion 50, distortions of the camera main bodies 38A and the lens portions 38B are corrected. In other words, the controller portion 50 also functions as an image position measuring apparatus including the distortion correcting units 70. If the camera main bodies 38A are the linear image sensors (line CCDs), the stroboscopic light sources 38C continue to apply lights to the photosensitive material 60 (alignment marks M) while the camera main bodies 38A are divisionally photographing the alignment marks M.

Here, a method of detecting the alignment marks M provided to the photosensitive material 60 and acquiring the relative positional relationship between the photosensitive material 60 and the exposure head unit 28 will be further described. A camera operation control portion in the controller portion 50 sends start signals to the camera portions 38 when an exposure stage operation control signal is input to the camera operation control portion. In response to the start signals, the camera portions 38 start and come into photographing standby states.

A trigger signal generating portion in the controller portion 50 generates trigger signals and sends them to the camera operation control portion and a stroboscopic light emission control portion when a pulse counter for counting output pulses from the linear encoder reaches a predetermined count value (e.g., when the counter counts the number of pulses corresponding to a position where the alignment marks M on the photosensitive material 60 transported by the exposure stage 20 moving in the going route enters photographing view angles of the camera portions 38).

At the time of input of the trigger signal, the camera operation control portion sends timing signals to the camera portions 38 and the camera portions 38 carry out photographing. The stroboscopic light emission control portion sends timing signals to the stroboscopic light sources 38C and the stroboscopic light sources 38C emit lights in synchronization with photographing operations of the camera portions 38. In this manner, the operating timing (moving timing) of the exposure stage 20, the photographing timing of the camera portions 38, and the light emitting timing of the stroboscopic light sources 38C are synchronized with each other.

Moreover, size data of the photosensitive material 60 is input to a width direction position setting portion together with the exposure stage operation control signal and the width direction position setting portion controls operation of the ball screw mechanism portions 36 to adjust positions in the width direction of the camera portions 38 with respect to the surface plate 18. As a result, the alignment marks M become less liable to get out of the fields of view of the camera portions 38 and the alignment marks M can be photographed by the camera portions 38 during movement of the exposure stage 20 in the going route.

The data photographed by the camera portions 38 is sent to a photographed data analyzing portion and an analysis of the photographed data is carried out. Because the photographed image data is basically analog data (a light amount is converted into a voltage immediately after photoelectric conversion), the analog data is converted into digital image data and the digital image data is managed as numerical values (density values) together with position data.

The digital image data analyzed by the photographed data analyzing portion is sent to a mark extracting portion and the alignment marks M are extracted and sent to a mark collating portion. The position data related to the digital image data is sent to an exposure position correction coefficient computing portion. In the mark collating portion, the image data of the extracted alignment marks M and mark data stored in advance in mark data memory are collated with each other and a signal indicating a match/mismatch is sent to the exposure position correction coefficient computing portion.

The exposure position correction coefficient computing portion recognizes an error between the position data corresponding to the mark data determined to be matching as a result of collation and the proper position data (in design) of alignment marks M, computes a correction coefficient of the exposure position (the exposure starting position in the moving direction of the exposure stage 20 and a shift position of a dot in the width direction of the exposure stage 20), and sends the coefficient to an exposure control system. Then, based on the correction coefficient, the image recording (exposure) starting time or the like by each head assembly 28A of the exposure head unit 28 is corrected so that the position of the image recorded on the photosensitive material 60 becomes proper.

In other words, the positional displacement, inclination with respect to the moving direction, dimensional accuracy errors, and the like of the photosensitive material 60 on the exposure stage 20 are obtained by computation based on the positions of the alignment marks M, a pitch of the alignment marks M, and the like in the image obtained from the input image data (reference position data) of the respective alignment marks M and the positions of the exposure stage 20 and the positions of the camera portions 38 when the alignment marks M are photographed to calculate the proper exposure position on the surface of the photosensitive material 60 to be exposed (lithography area).

The image data according to the exposure pattern is temporarily stored in a memory in the controller portion 50. Therefore, at the time of image exposure by the respective head assemblies 28A, control signals generated based on the image data of the exposure pattern stored in the memory are subjected to correction control (alignment) so that the image is formed by exposure while aligned in the proper exposure position. The image data is data expressing densities of the respective pixels forming the image by binary values (presence or absence of records of dots).

Moreover, on the farther side including the exposure head unit 28 of the surface plate 18, a chamber 42 is provided to be further isolated from space in the case portion 12A. In other words, the exposure head unit 28 and the alignment unit 30 are disposed in the chamber 42, the surface plate 18 extends from inside the chamber 42 to the stage portion 12B, and only the exposure stage 20 moves into and out of the chamber 42.

One end portion of an air duct 44 is attached to a ceiling portion of the chamber 42 and the other end portion of the air duct 44 is attached to an air exhaust port of an air blower 46. Therefore, if the air blower 46 is actuated, air is sent into the chamber 42 through the air duct 44.

If air is sent into the chamber 42, a positive pressure is caused in the chamber 42 and the air flows into the stage portion 12B through the space for movement of the exposure stage 20. With this flow, dust can be discharged from areas around the exposure head unit 28 and the alignment unit 30 which should avoid the dust most and it is possible to prevent entry of new dust by pressure difference even when the opening/closing lid 14 is open (when the photosensitive material 60 is loaded on and unloaded from the exposure stage 20).

A neutralization device (ionizer) 52 is disposed in the width direction of the surface plate 18 on the near side of the exposure head unit 28 in the going direction of the exposure stage 20, i.e., on the side near the stage portion 12B. The neutralization device 52 is formed of a hollow pipe-shaped blow-off portion 52A and an ion generating portion 52B for supplying ionized air to the blow-off portion 52A to blow off the ionized air toward the surface plate 18.

The photosensitive material 60 has a property of attracting dust when it is electrostatically charged and bears electrical charges due to a base material of the photosensitive material 60. The dust attracted and adhering thereto due to static electricity cannot be totally swept away by the flow of air and therefore is swept away by the neutralization device 52. To put it concretely, corona discharge is generated between a ground electrode and a discharging electrode to generate ions in the ion generating portion 52B and the ions are guided by an air blowing source to the blow-off portion 52A and blown off, thereby carrying out neutralization to remove electricity by using ions of the opposite polarity to the electrostatically-charged dust.

As a result, when the exposure stage 20 on which the photosensitive material 60 is loaded moves on the surface plate 18, the surface of the photosensitive material 60 is neutralized, the dust adhering due to the static electricity can be removed from the surface, and the dust floating above the exposure stage 20 can be removed by the air blow.

[Operation of Exposure Apparatus]

Next, operation of the above-described exposure apparatus 10 will be described. As the photosensitive material 60 to be subjected to image exposure by the exposure apparatus 10, there are a board and a glass plate such as a printed wiring board and a liquid crystal display device as materials on which patterns are formed (image-exposured) and on surfaces of which photoresist such as photosensitive epoxy resin is applied, or dry films are laminated.

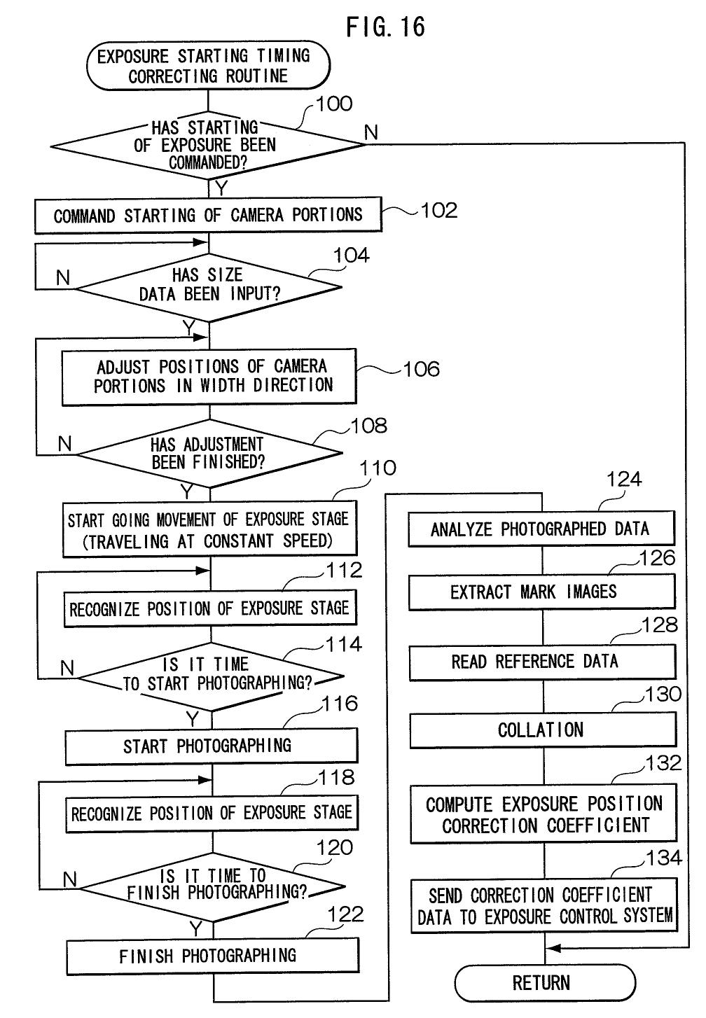

FIG. 16 shows a flow chart showing the exposure starting timing correcting routine. First, the photosensitive material 60 is loaded on the exposure stage 20 (load surface). Then, the vacuum pump or the like causes negative pressure in the grooves to thereby suck and retain the photosensitive material 60 on the load surface. Then, in step 100, whether or not starting of exposure has been commanded is determined. In case of affirmative determination, the routine goes to step 102 to command starting of the camera portions 38. In case of negative determination in step 100, the routine ends.

If starting of the camera portions 38 is commanded in step 102, the routine then goes to step 104 where whether or not size data of the photosensitive material 60 has been input is determined. In case of affirmative determination in step 104, the routine goes to step 106 to carry out control for driving the ball screw mechanism portions 36 to adjust the positions of the camera portions 38 in the width direction with respect to the surface plate 18 based on the input size data.

In step 108, whether or not the adjustment has been finished is determined. In case of affirmative determination, the routine goes to step 110 to start going movement of the exposure stage 20 on the load surface of which the photosensitive material 60 is sucked and retained. In other words, the exposure stage 20 is moved at a constant speed from the stage portion 12B to the farther side of case portion 12A along the sliding rails 22 on the surface plate 18 by the driving force of the linear motor portion 24.

During the going movement of the exposure stage 20, the pulse counter counts the output pulses from the linear encoder provided to the linear motor portion 24 to thereby recognize the position of the exposure stage 20 (the position can be also obtained based on driving pulses of the linear motor portion 24) in step 112 and whether or not it is the time for photographing is determined in step 114.

In other words, whether or not the tip end of the exposure stage 20 in the moving direction is in a position immediately before passing a position directly below the camera portions 38 is determined. In case of affirmative determination, the routine goes to step 116 to start photographing. As a result, the alignment marks M provided in advance to the photosensitive material 60 are photographed by the camera portions 38.

In other words, at the time when the alignment marks M reach predetermined photographing positions, the stroboscopic light sources 38C of the camera portions 38 emit lights. Then, the stroboscopic lights that have been applied to the photosensitive material 60 and have been reflected from the upper face of the photosensitive material 60, are input to the camera main bodies 3 8A through the lens portions 38B, thereby photographing the alignment marks M.

Then, in the next step 118, the position of the exposure stage 20 is checked. In step 120, whether or not it is a time to finish photographing is determined. In other words, whether or not the rear end of the exposure stage 20 in the moving direction has finished passing a position directly below the alignment unit 30 is determined. In case of affirmative determination, the routine goes to step 122 to finish the photographing.

At the time of photographing the alignment marks M, distortions of the camera main bodies 38A and/or lens portions 38B are corrected by the distortion correcting units 70. In other words, if the camera main body 38A (image pickup device) is an area CCD (two-dimensional), the correction vectors H (distortion correction data) for respective areas 74 are retained as fixed values to correct the photographed image data as shown in FIG. 9 or the correction vectors H (distortion correction data) for respective areas 74 are retained as functions f of (x, y) to correct the photographed image data as shown in FIGS. 10A and 10B.

If the camera main body 38A (image pickup device) is a line CCD (one-dimensional) (see FIG. 11), the correction vectors H (distortion correction data) are only in one direction (only in the direction x) as shown in FIG. 12 to similarly correct the photographed image data. If the correction vectors H (distortion correction data) are only in one direction (only in direction x), there is an advantage that the photographed image data can be corrected easily. Moreover, if the camera main body 38A (image pickup device) is the line CCD (one-dimensional), the alignment marks M are photographed while divided in a plurality of rows in the scanning direction (in the direction of the arrow D), which also suppresses the influences of the distortions of the camera main body 38A (image pickup device).

Furthermore, if the lens portion 38B can be turned and fixed as shown in FIG. 14, the area of the lens to be used becomes small especially when the camera main body 38A (image pickup device) is the line CCD (one-dimensional) and therefore it is possible to easily select a portion where the amount of distortion is the smallest. As a result, it is possible to improve the accuracy of photographing (accuracy of measurement of the positions) of the alignment marks M.

In general, the distortions increase when the magnification of the lens is increased. With the above configuration, however, it is possible to easily select the area where the influence of the distortion is the smallest even if the magnification of the lens is increased and therefore it is possible to use a relatively inexpensive lens. Therefore, there is also a cost advantage.

After the alignment marks M are photographed by the camera portions 38 in this manner, the photographed data are analyzed in step 124. Then, the routine goes to step 126 to extract the image data corresponding to the alignment marks M. In the next step 128, reference data are read from the mark data memory and the photographed and extracted mark image data and the reference data stored in advance are collated with each other in step 130.

Then, in the next step 132, the exposure position correction coefficient is computed based on the collation results. The routine goes to step 134 to send the computed correction coefficient data to the exposure control system. As a result, the exposure starting timings and the like by the respective head assemblies 28A in the exposure head unit 28 are corrected to make the position of the image recorded on the photosensitive material 60 proper.

The alignment marks M provided on the photosensitive material 60 are detected while the exposure stage 20 moves at the predetermined speed. Therefore, even if the actual alignment marks M are circles, the photographed images become substantially elongated circles depending on a shutter speed in photographing and the like if the marks M are photographed while moving the exposure stage 20.

Therefore, the mark data stored in the mark data memory are images (elongated circular images) into which photographing environments (the shutter speeds, the moving speed of the exposure stage 20, and the like) of the camera portions 38 are factored. In other words, by storing the mark data not corresponding to actual circles but corresponding to the images actually photographed while moving the exposure stage 20 under the photographing environments, the collation is made proper.

When the image recording position correction (exposure starting timing correction) is finished in this manner, returning movement of the exposure stage 20 on the load surface of which the photosensitive material 60 is sucked and retained is started. In other words, the exposure stage 20 is moved at a constant speed from the case portion 12A toward the stage portion 12B along the sliding rails 22 on the surface plate 18 by the driving force of the linear motor portion 24.

During the returning movement of the exposure stage 20, the pulse counter counts the output pulses from the linear encoder provided to the linear motor portion 24 to thereby recognize the position of the exposure stage 20 (the position can be also obtained based on driving pulses of the linear motor portion 24).

Then, the exposure stage 20 passes through the exposure head unit 28. At this time, in the exposure head unit 28, laser lights are applied to the DMDs based on the corrected exposure starting timing and the laser lights reflected when the micromirrors of the DMDs are in ON states are guided by optical systems to the photosensitive material 60 and form the image on the photosensitive material 60 (surface to be exposed).

In other words, the image data stored in the memory of the controller portion 50 are successively read out by plural lines at a time and the control signal is generated for each head assembly 28A based on the read image data. To the control signal, correction of the alignment-measured exposure positional displacement for the photosensitive material 60 is added by correction control (alignment). The photosensitive material 60 is exposed in units of pixels, the number of pixels being substantially equal to the number of pixels used by the DMDs.

In this way, as the photosensitive material 60 moves at the constant speed with the exposure stage 20, the belt-shaped exposed area 28C is formed for each head assembly 28A in an opposite direction to the moving direction of the exposure stage 20 (see FIG. 6A). When the exposure of the photosensitive material 60 is finished and the exposure stage 20 returns to the initial position, suction of the photosensitive material 60 by the exposure stage 20 is released and the photosensitive material 60 is transported to a transporting conveyer (not shown) outside the apparatus and transported to the next process.

As described above, because the exposure apparatus 10 includes the distortion correcting units 70 for correcting the distortions of the camera main bodies 38A and/or lens portions 38B, it is possible to improve the accuracy of photographing (accuracy of measurement of the positions) of the alignment marks M. Therefore, it is possible to accurately carry out the exposure of the lithography area (surface to be exposed) of the photosensitive material 60.

Moreover, in the embodiment, the alignment marks M for correcting the position of the image to be recorded on the photosensitive material 60 are read while moving the exposure stage 20 (photosensitive material 60) and therefore it is possible to increase processing efficiency (productivity). Furthermore, in the embodiment, the exposure stage 20 reciprocates and therefore the exposure head unit 28 and the alignment unit 30 can be disposed close to each other to thereby make the exposure apparatus 10 itself compact (reduce the installation space).

Furthermore, though the DMDs are used as the spatial light modulators and are turned on and off while keeping illuminated time constant to thereby generate the dot patterns in the embodiment, pulse-width modulation may be carried out by on time ratio (duty) control. It is also possible to make one illuminated time extremely short to generate the dot patterns based on the number of times the DMDs are illuminated.

Moreover, though the exposure head unit 28 including the DMDs as the spatial light modulators has been described in the embodiment, transmissive spatial light modulators (LCD) can be used in addition to the reflection type spatial light modulators. For example, MEMS (Micro Electro Mechanical Systems) Spatial Light Modulator (SLM) and spatial light modulators other than that of the MEMS type, e.g., an optical device (PLZT device) for modulating transmitted light by electro-optical effect and a liquid crystal shutter array such as a liquid crystal optical shutter (FLC) can be used.

MEMS is a generic term used to refer to microscopic systems formed by integrating a micro-scale sensor, actuator and control circuit obtained by micromachining technology based on IC manufacturing process and the MEMS type spatial light modulator refers to the spatial light modulator driven by electromechanical operation utilizing electrostatic force. Furthermore, it is also possible to use a plurality of Grating Light Valves (GLV) in a two-dimensional form. In these configurations using the reflection type spatial light modulator (GLV) and the transmissive spatial light modulator (LCD), a lamp or the like can be used as a light source in addition to the above-described laser.

Moreover, as the light source, a fiber array light source including a plurality of multiplexed laser light sources, a fiber array light source including arrayed fiber light sources each having one optical fiber for emitting incoming laser light from a single semiconductor laser having one light emitting point, a light source (e.g., an LD array, an organic EL array) in which a plurality of light emitting points are arranged two-dimensionally, and the like can be used.

Furthermore, for this exposure apparatus, any of a photon mode photosensitive material on which information is directly recorded by exposure and a heat mode photosensitive material on which information is recorded by heat generated by exposure can be used. If the photon mode photosensitive material is used, a GaN semiconductor laser, a wavelength conversion solid-state laser, and the like are used as a laser. If the heat mode photosensitive material is used, an AlGaAs semiconductor laser (infrared laser), a solid-state laser, and the like are used as a laser.

### INDUSTRIAL APPLICABILITY

By applying the present invention to a laser exposure apparatus for forming an image such as a wiring pattern on a work such as a printed wiring board, it is possible to carry out adjustment of a position of the image with high accuracy.

### EXPLANATION OF REFERENCE NUMERALS

10 exposure apparatus
20 exposure stage (stage)
28 exposure head unit (exposure unit)
30 alignment unit (image position measuring apparatus)
38 camera portion (photographing unit)
38A camera main body (image pickup device)
38B lens portion (lens)
50 controller portion (image position measuring apparatus)
60 photosensitive material (work)
70 distortion correcting unit (correction unit)

What is claimed is:

1. An image position measuring apparatus comprising
a photographing unit including an image pickup device and/or a lens to measure a position of a reference mark formed on a work and
a correcting unit for correcting distortion(s) of the image pickup device and/or the lens.

2. The image position measuring apparatus according to claim 1, wherein the correcting unit measures a distortion of a photographed image caused by the distortion(s) of the image pickup device and/or the lens in advance and corrects the photographed image data based on distortion data obtained by the measurement.

3. The image position measuring apparatus according to claim 2, wherein the distortion data includes data calculated from data obtained by photographing a reference chart in advance.

4. The image position measuring apparatus according to claim 1, wherein the photographing unit includes a mechanism for turning the lens about an optical axis of the lens and for fixing the lens.

5. The image position measuring apparatus according to claim 1, wherein the photographing unit includes a plurality of image pickup devices and the plurality of image pickup devices are arranged substantially one-dimensionally.

6. The image position measuring apparatus according to claim 1, further comprising a stage on which the work can be loaded, wherein the stage is movable along a predetermined transporting path and the reference mark formed on the work is photographed during movement of the stage.

7. An exposure apparatus comprising
an image position measuring apparatus including a photographing unit having an image pickup device and/or a lens to measure a position of a reference mark formed on a work and a correcting unit for correcting distortion(s) of the image pickup device and/or the lens and
an exposure unit for exposing the work based on image data corrected based on positional information of the reference mark photographed by the image position measuring apparatus.

8. The exposure apparatus according to claim 7, wherein the correcting unit measures a distortion of a photographed image caused by the distortion(s) of the image pickup device and/or the lens in advance and corrects the photographed image data based on distortion data obtained by the measurement.

9. The exposure apparatus according to claim 8, wherein the distortion data includes data calculated from data obtained by photographing a reference chart in advance.

10. The exposure apparatus according to claim 7, wherein the photographing unit includes a mechanism for turning the lens about an optical axis of the lens and for fixing the lens.

11. The exposure apparatus according to claim 7, wherein the photographing unit includes a plurality of image pickup devices and the plurality of image pickup devices are arranged substantially one-dimensionally.

12. The exposure apparatus according to claim 7, further comprising a stage on which the work can be loaded, wherein the stage is movable along a predetermined transporting path and the reference mark formed on the work is photographed during movement of the stage.
